(19) United States
(12) Patent Application Publication
(10) Pub. No.: US 2026/0022737 A1
(43) Pub. Date: Jan. 22, 2026

(54) SEAL RING FOR A BEARING ASSEMBLY

(71) Applicant: Schaeffler Technologies AG & Co. KG, Herzogenaurach (DE)

(72) Inventor: Michael White, Lake Wylie, SC (US)

(73) Assignee: Schaeffler Technologies AG & Co. KG, Herzogenaurach (DE)

(21) Appl. No.: 18/779,929

(22) Filed: Jul. 22, 2024

(51) Int. Cl. F16C 33/80

(52) U.S. Cl. CPC F16C 33/80

(57) ABSTRACT

A seal ring for a bearing assembly includes an inner sleeve having an inner surface that defines a hollow for receiving a shaft therethrough, and an outer labyrinth ring fixed to the inner sleeve and including an interior surface that faces the inner sleeve and an exterior surface opposite the interior surface. The exterior surface forms a plurality of crests and at least one trough.

### FIELD OF THE DISCLOSURE

The present disclosure generally relates to a seal ring for a bearing assembly. More particularly, the present disclosure relates to a seal ring for a bearing assembly that includes an outer labyrinth ring.

### BACKGROUND OF THE DISCLOSURE

Some bearing assemblies utilize seal rings, such as labyrinth seal rings, that protect components of the bearing assembly from outside contaminants. Seal rings are often formed of a single piece of solid metal.

### SUMMARY OF THE DISCLOSURE

According to a first aspect of the present disclosure, a seal ring for a bearing assembly includes an inner sleeve having an inner surface that defines a hollow for receiving a shaft therethrough, and an outer labyrinth ring fixed to the inner sleeve and including an interior surface that faces the inner sleeve and an exterior surface opposite the interior surface. The exterior surface forms a plurality of crests and at least one trough.

Embodiments of the first aspect of the disclosure can include any one or a combination of the following features:
the outer labyrinth ring is formed of metal, and the inner sleeve is formed of a polymeric material that is applied to the interior surface of the outer labyrinth ring;
the inner sleeve includes an outer surface opposite the inner surface, and the inner sleeve and the outer labyrinth ring are fixed to each other such that the interior surface of the outer labyrinth ring and the outer surface of the inner sleeve cooperate to define an interior volume disposed between the inner sleeve and the outer labyrinth ring;
the interior volume is substantially devoid of solid and liquid material;
the inner sleeve is formed of metal, and the outer labyrinth ring is formed of metal;
the outer labyrinth ring is welded to the inner sleeve;
the outer labyrinth ring is welded to the inner sleeve circumferentially at a first axial end of the outer labyrinth ring and circumferentially at a second axial end of the outer labyrinth opposite the first axial end, such that the interior volume is sealed from an exterior environment of the seal ring;
a rubber bonded coating applied to the inner surface of the inner sleeve along a minority of the axial length of the inner sleeve; and
the exterior surface of the outer labyrinth ring forms the plurality of crests and the at least one trough, and the plurality of crests includes a first crest, a second crest, and a third crest, wherein the second crest is positioned axially between the first and third crests, and the at least one trough includes a first trough disposed axially between the first crest and the second crest and a second trough disposed axially between the second crest and the third crest.

According to a second aspect of the present disclosure, a method of manufacturing a seal ring for a bearing assembly includes the steps of providing an inner sleeve that includes an inner surface and an outer surface opposite the inner surface, and fixing an outer labyrinth ring that includes an interior surface and an exterior surface opposite the interior surface to the inner sleeve, such that the interior surface of the outer labyrinth ring and the outer surface of the inner sleeve cooperate to define an interior volume disposed between the inner sleeve and the outer labyrinth ring.

Embodiments of the second aspect of the disclosure can include any one or a combination of the following features:
the exterior surface of the outer labyrinth ring forms a plurality of crests and at least one trough;
the step of fixing the outer labyrinth ring to the inner sleeve comprises welding the outer labyrinth ring to the inner sleeve;
the step of fixing the outer labyrinth ring to the inner sleeve comprises circumferentially welding the outer labyrinth ring to the inner sleeve at a first axial end of the outer labyrinth ring and circumferentially welding the outer labyrinth ring to the inner sleeve at a second axial end of the outer labyrinth ring opposite the first axial end;
the interior volume is sealed from an exterior environment of the seal ring; and
the step of applying a rubber bonded coating to the inner surface of the inner sleeve along a minority of the axial length of the inner sleeve.

According to a third aspect of the present disclosure, a method of manufacturing a seal ring for a bearing assembly includes the steps of providing an outer labyrinth ring that includes an interior surface and an exterior surface opposite the interior surface, wherein the exterior surface of the outer labyrinth ring forms a plurality of crests and at least one trough, and applying a polymeric material to the interior surface of the outer labyrinth ring for the forming of an inner sleeve of the polymeric material that is configured to receive a shaft therethrough.

Embodiments of the third aspect of the disclosure can include any one or a combination of the following features:
the polymeric material is a rubber and the interior surface of the outer labyrinth ring forms at least a portion of a mold for receiving the rubber therein;
the polymeric material is a thermoplastic and the interior surface of the outer labyrinth ring forms at least a portion of a mold for receiving the thermoplastic therein;
the outer labyrinth ring is formed of metal; and
the exterior surface of the outer labyrinth ring forms the plurality of crests and the at least one trough, and the plurality of crests includes a first crest, a second crest, and a third crest, wherein the second crest is positioned axially between the first and third crests, and the at least one trough includes a first trough disposed axially between the first crest and the second crest and a second trough disposed axially between the second crest and the third crest.

These and other features, advantages, and objects of the present disclosure will be further understood and appreciated by those skilled in the art by reference to the following specification, claims, and appended drawings.

### BRIEF DESCRIPTION OF THE DRAWINGS

In the drawings:

FIG. 1 is an exploded perspective view of a bearing assembly, according to one embodiment;

FIG. 2 is an exploded perspective view of a seal ring for a bearing assembly, illustrating an outer labyrinth ring and an inner sleeve that is configured to be fixed with the outer labyrinth ring, according to one embodiment;

FIG. 3 is an elevational view of a seal ring for a bearing assembly, according to one embodiment;

FIG. 4 is a cross-sectional view of the seal ring of FIG. 3 taken at line IV-IV, illustrating an inner sleeve of the seal ring, an outer labyrinth ring of the seal ring that includes a plurality of crests and a plurality of troughs, and a shaft that extends through a hollow defined by an inner surface of the inner sleeve in phantom, according to one embodiment;

FIG. 5 is a cross-sectional view of a seal ring, illustrating an outer labyrinth ring and an inner sleeve fixed to the outer labyrinth ring, according to one embodiment;

FIG. 6 is a cross-sectional view of a seal ring for a bearing assembly, illustrating an outer labyrinth ring and an inner sleeve fixed to the outer labyrinth ring, according to one embodiment;

FIG. 7 is an elevational view of a seal ring for a bearing assembly that includes an inner sleeve and an outer labyrinth ring, according to one embodiment;

FIG. 8 is a cross-sectional view of the seal ring of FIG. 7 taken at line VIII-VIII, illustrating an inner sleeve formed of a polymeric material that is applied to an interior surface of the outer labyrinth ring, according to one embodiment;

FIG. 9 is a block diagram of a method of manufacturing a seal ring for a bearing assembly, according to one embodiment; and

FIG. 10 is a block diagram of a method of manufacturing a seal ring for a bearing assembly, according to one embodiment.

The components in the figures are not necessarily to scale, emphasis instead being placed upon illustrating the principles described herein.

### DETAILED DESCRIPTION

Additional features and advantages of the disclosure will be set forth in the detailed description which follows and will be apparent to those skilled in the art from the description, or recognized by practicing the disclosure as described in the following description, together with the claims and appended drawings.

As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

In this document, relational terms, such as “first” and “second,” “top” and “bottom,” and the like, are used solely to distinguish one entity or action from another entity or action, without necessarily requiring or implying any actual such relationship or order between such entities or actions.

For purposes of this disclosure, the term “coupled” (in all of its forms: couple, coupling, coupled, etc.) generally means the joining of two components (electrical or mechanical) directly or indirectly to one another. Such joining may be stationary in nature or movable in nature. Such joining may be achieved with the two components (electrical or mechanical) and/or any additional intermediate members. Such joining may include members being integrally formed as a single unitary body with one another (i.e., integrally coupled) or may refer to joining of two components. Such joining may be permanent in nature, or may be removable or releasable in nature, unless otherwise stated.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

As used herein, the terms “the,” “a,” or “an,” mean “at least one,” and should not be limited to “only one” unless explicitly indicated to the contrary. Thus, for example, reference to “a component” includes embodiments having two or more such components unless the context clearly indicates otherwise.

As used herein, the term “axial” and derivatives thereof, such as “axially,” shall be understood to refer to a direction along the axis of a shaft configured to rotate in operation of the apparatus described herein. Further, the term “radial” and derivatives thereof, such as “radially,” shall be understood in relation to the axis of the aforementioned shaft. For example, “radially outboard” refers to further away from the axis, while “radially inboard” refers to nearer to the axis. The term “circumferential” and derivatives thereof, such as “circumferentially,” shall be understood in relation to the axis of the aforementioned shaft.

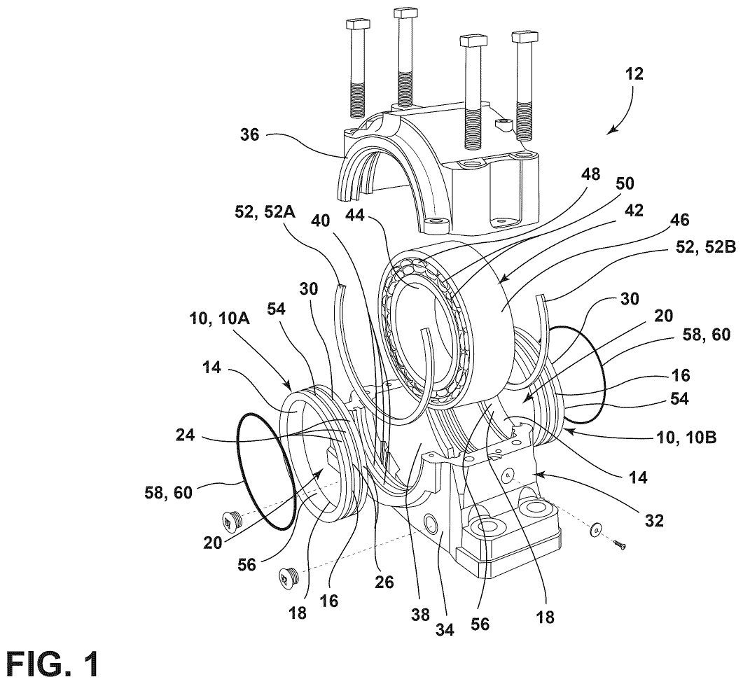

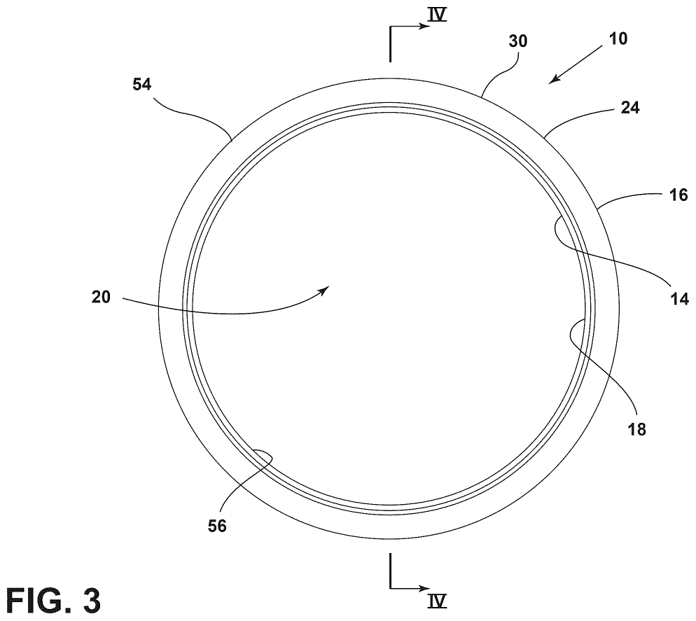

Referring now to FIGS. 1-10, a seal ring 10 for a bearing assembly 12 includes an inner sleeve 14 and an outer labyrinth ring 16. The inner sleeve 14 includes an inner surface 18 that defines a hollow 20 for receiving a shaft 22 therethrough. The outer labyrinth ring 16 is fixed to the inner sleeve 14 and forms a plurality of crests 24 and at least one trough 26. The outer labyrinth ring 16 includes an interior surface 28 that faces the inner sleeve 14 and an exterior surface 30 opposite the interior surface 28.

Referring now to FIG. 1, a bearing assembly 12 includes a housing 32. A variety of types of housings 32 are contemplated. In the embodiment illustrated in FIG. 1, the housing 32 includes a base 34 and a cap 36 that is configured to be fastened to the base 34 to house various components of the bearing assembly 12. The housing 32 of the bearing assembly 12 can include an annular interior portion 38. The annular interior portion 38 of the housing 32 may include a plurality of grooves 40 for engagement with other components of the bearing assembly 12, as described further herein. The bearing assembly 12 further includes a bearing 42 that is configured to be disposed radially inboard of the annular interior portion 38 of the housing 32. In the embodiment illustrated in FIG. 1, the bearing 42 includes an inner ring 44, an outer ring 46, a cage 48 disposed radially between the inner and outer rings 44, 46, and a plurality of rolling elements 50 retained by the cage 48 and disposed radially between the inner and outer rings 44, 46. The outer ring 46 is positioned radially outboard of the inner ring 44, and a shaft 22 is configured to be received within the inner ring 44. A variety of types of rolling elements 50 are contemplated (e.g., balls, rollers, needles, etc.). Further, the bearing 42 can be a variety of types of bearings 42 (e.g., spherical bearing, ball bearing, roller bearing, etc.).

As illustrated in FIG. 1. the bearing assembly 12 may include one or more retainers 52. The one or more retainers 52 may be configured to limit axial displacement of the bearing 42 along the annular interior portion 38 of the housing 32 in the assembled condition of the bearing assembly 12. In the embodiment illustrated in FIG. 1, first and second retainers 52A, 52B are configured to be received within corresponding grooves 40 of the annular interior portion 38 of the housing 32 on opposite axial sides of the bearing 42 to limit axial movement of the bearing 42 in both axial directions.

Referring still to FIG. 1, the bearing assembly 12 may include the seal ring 10. In various implementations, the bearing assembly 12 may include a plurality of seal rings 10. For example, as illustrated in FIG. 1, the bearing assembly 12 includes a first seal ring 10A that is configured to be disposed on a first axial side of the bearing 42 in the assembled condition of the bearing assembly 12, and a second seal ring 10B that is configured to be disposed on a second axial side of the bearing 42 in the assembled condition of the bearing assembly 12. The seal ring 10 may be configured to be coupled with the housing 32 of the bearing assembly 12 in the assembled condition of the bearing assembly 12, such that the seal ring 10 and the housing 32 cooperate to seal the bearing 42 of the bearing assembly 12 from outside contaminants. For example, in the embodiment illustrated in FIG. 1, the seal ring 10 is a labyrinth seal ring 10 that includes a plurality of crests 24 and a plurality of troughs 26 on a radially outboard side 54 thereof that are configured to engage with corresponding grooves 40 of the annular interior surface 38 of the housing 32 in the assembled condition of the bearing assembly 12. The plurality of crests 24 of the seal ring 10 being received within the corresponding plurality of grooves 40 of the housing 32 creates a labyrinth that effectively seals the bearing 42 of the bearing assembly 12 from contaminants that would enter between the seal ring 10 and the housing 32. In operation of the bearing assembly 12, a shaft 22 is configured to extend through a hollow 20 defined by a radially inboard side 56 of the seal ring 10. In various implementations, a sealing element 58, such as the O-rings 60 illustrated in FIG. 1, are configured to extend radially between the radially inboard side 56 of the seal ring 10 and the shaft 22 extending therethrough to seal the bearing assembly 12 with the shaft 22 to prevent the intrusion of contaminants.

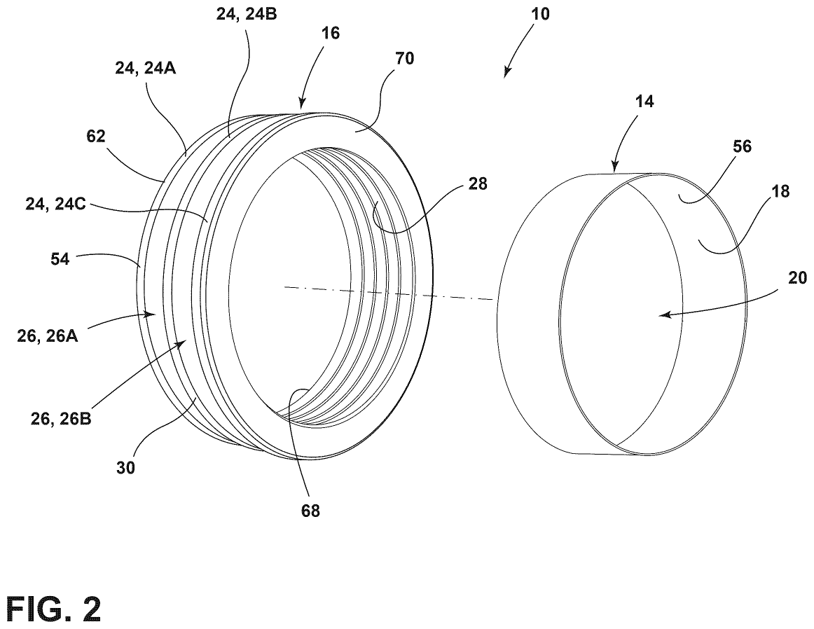

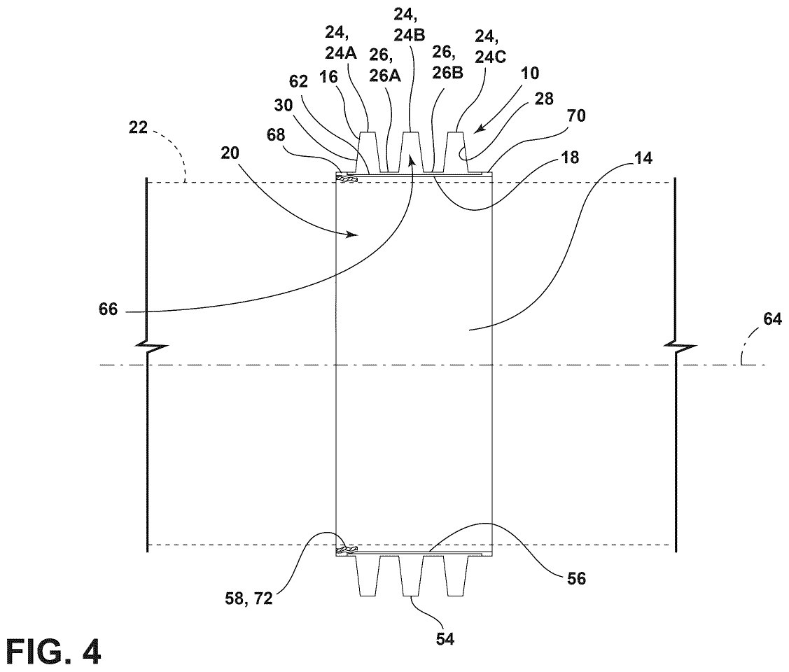

Referring now to FIGS. 2-8, in various embodiments, the seal ring 10 includes the inner sleeve 14 and the outer labyrinth ring 16. The inner sleeve 14 may include the inner surface 18 that defines the hollow 20 for receiving the shaft 22 therethrough, as illustrated exemplarily in FIG. 4. In various implementations, the inner sleeve 14 includes an outer surface 62 that is opposite the inner surface 18. In various implementations, the inner sleeve 14 is a metal sleeve, such as a steel sleeve. In some implementations, the inner sleeve 14 may be formed of a polymeric material, such as rubber or thermoplastic, as described further herein.

Referring still to FIGS. 2-8, the outer labyrinth ring 16 includes an interior surface 28 and an exterior surface 30 that is opposite the interior surface 28. In various implementations, the exterior surface 30 of the outer labyrinth ring 16 forms a plurality of crests 24 and at least one trough 26. For example, in the embodiments illustrated in FIGS. 4-6 and 8, the exterior surface 30 of the outer labyrinth ring 16 forms the plurality of crests 24 and the at least one trough 26. In the illustrated embodiment, the plurality of crests 24 includes a first crest 24A, a second crest 24B, and a third crest 24C, wherein the second crest 24B is positioned axially between the first and third crests 24A, 24C. The at least one trough 26 includes a first trough 26A disposed axially between the first crest 24A and the second crest 24B, and a second trough 26B disposed axially between the second crest 24B and the third crest 24C.

In some implementations, at least one of the plurality of crests 24 formed by the exterior surface 30 of the outer labyrinth ring 16 is shaped such that the at least one crest 24 is substantially radially uniform along an axial extent of the crest 24 and a circumferential extent of the crest 24. In other words, the distance that the crest 24 is from an axis 64 about which the shaft 22 is configured to rotate is substantially the same at any point along the axial extent of the crest 24 and the circumferential extent of the crest 24. For example, as illustrated in FIG. 4, each of the plurality of crests 24 has a radial dimension that is substantially uniform along an axial extent of each of the crests 24 and along the circumferential extent of each of the crests 24, respectively.

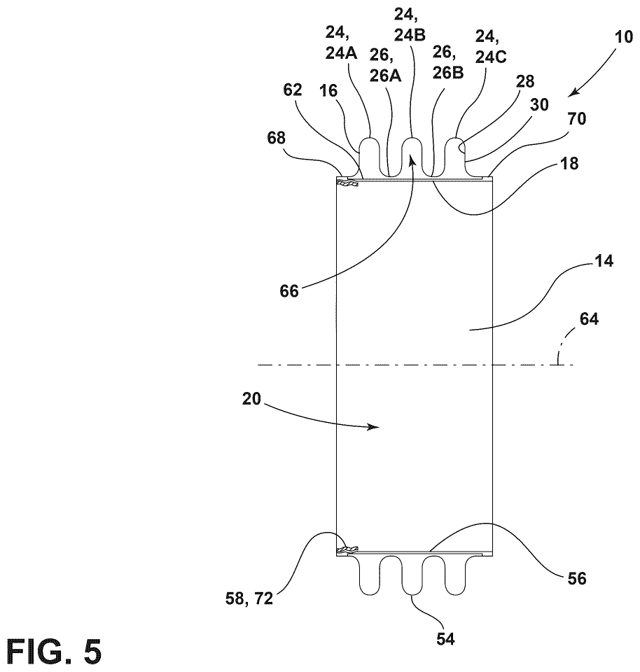

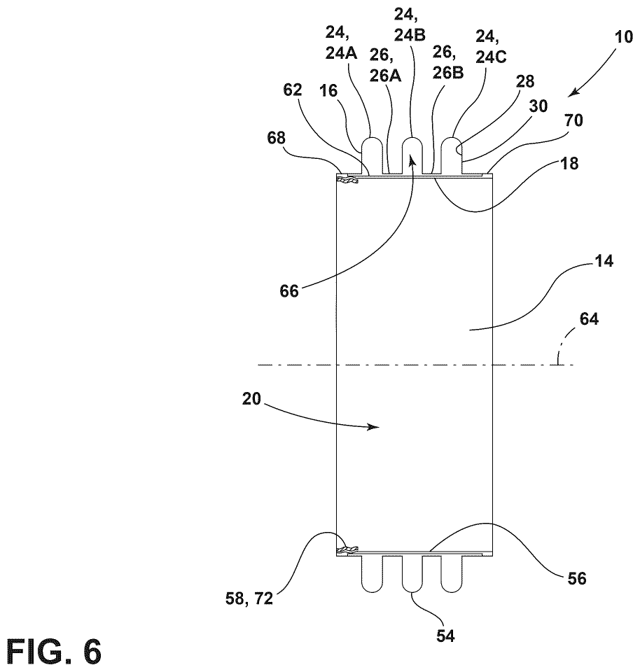

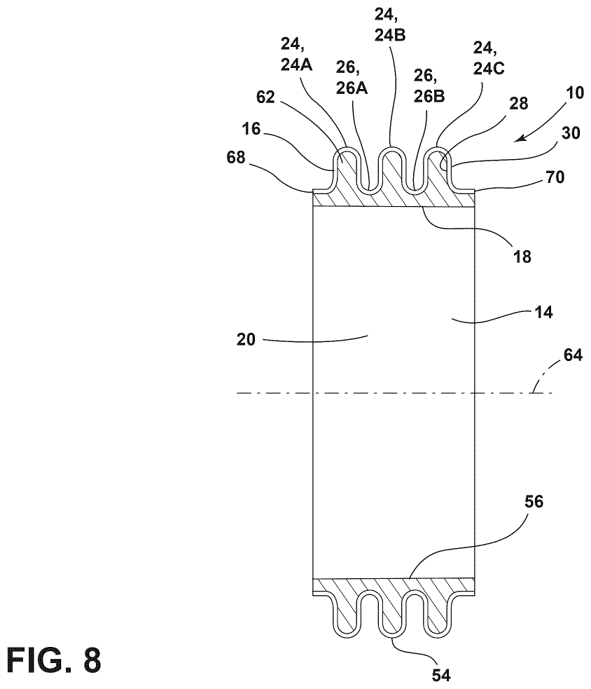

In some implementations, the at least one trough 26 formed by the exterior surface 30 of the outer labyrinth ring 16 is substantially radially uniform along an axial extent of the at least one trough 26 and the circumferential extent of the at least one trough 26. For example, as illustrated in FIGS. 4 and 5, each of the plurality of troughs 26 formed by the exterior surface 30 of the outer labyrinth ring 16 has a substantially uniform radial dimension along the axial extent and circumferential extent of each trough 26. In some implementations, the exterior surface 30 of the outer labyrinth ring 16 that forms the plurality of crests 24 and the plurality of troughs 26 is contoured such that at least a portion of the exterior surface 30 curves in the radial direction as the exterior surface 30 extends axially. In some implementations, at least one crest 24 is formed on such a curved portion. For example, as illustrated in FIGS. 5 and 6, each of the crests 24 formed by the exterior surface 30 of the outer labyrinth ring 16 is disposed at the radially-outboard-most portion of respective curved portions of the exterior surface 30. In some implementations, at least one trough 26 formed by the exterior surface 30 of the outer labyrinth ring 16 is formed at the radially-inboard-most portion of a curved portion of the exterior surface 30. For example, as illustrated in FIGS. 6 and 8, each of the troughs 26 of the exterior surface 30 of the outer labyrinth ring 16 is formed at the radially-inboard-most point of respective curved portions of the exterior surface 30 of the outer labyrinth ring 16.

Referring still to FIGS. 2-8, in various implementations, the outer labyrinth ring 16 is formed of metal (e.g., steel). In various implementations, the outer labyrinth ring 16 may be formed of sheet metal. In such implementations, the interior surface 28 of the outer labyrinth ring 16 may generally follow the contours of the exterior surface 30 of the outer labyrinth ring 16, as illustrated in FIGS. 4-6 and 8.

Referring still to FIGS. 2-8, the outer labyrinth ring 16 is configured to be fixed to the inner sleeve 14. In some implementations, the inner sleeve 14 and the outer labyrinth ring 16 are fixed to each other such that the interior surface 28 of the outer labyrinth ring 16 and the outer surface 62 of the inner sleeve 14 cooperate to define an interior volume 66 disposed between the inner sleeve 14 and the outer labyrinth ring 16. For example, as illustrated in FIGS. 4-6, the inner sleeve 14 and the outer labyrinth ring 16 cooperate to define an interior volume 66 disposed therebetween. In various implementations, the interior volume 66 defined by the inner sleeve 14 and the outer labyrinth ring 16 is substantially devoid of solid and liquid material. In some embodiments, the outer labyrinth ring 16 is welded to the inner sleeve 14. In an exemplary embodiment, the inner sleeve 14 is formed of metal, and the outer labyrinth ring 16 is formed of metal. The outer labyrinth ring 16 is welded to the inner sleeve 14 circumferentially at a first axial end 68 of the outer labyrinth ring 16 and circumferentially at a second axial end 70 of the outer labyrinth ring 16 opposite the first axial end 68, such that the interior volume 66 is sealed from an exterior environment of the seal ring 10.

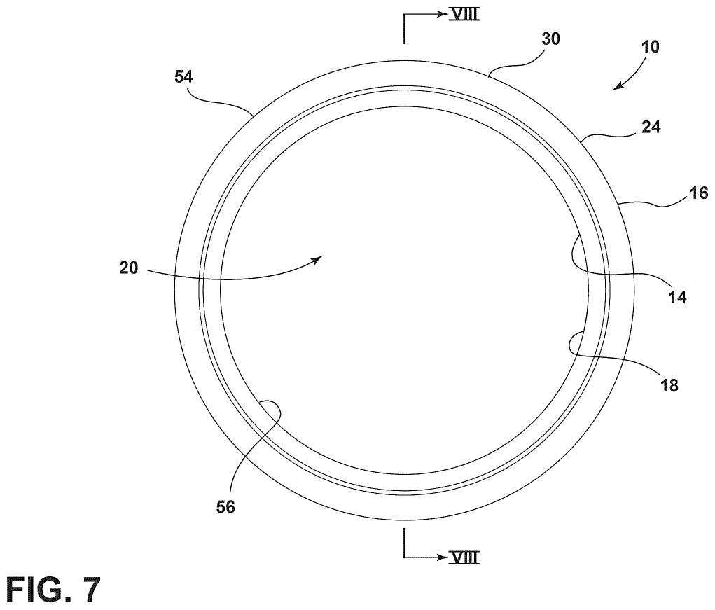

Referring now to FIGS. 7 and 8, in some implementations, the outer labyrinth ring 16 is formed of metal, and the inner sleeve 14 is formed of a polymeric material that is applied to the interior surface 28 of the outer labyrinth ring 16. In some embodiments, the interior surface 28 of the outer labyrinth ring 16 may form at least a portion of a mold into which the polymeric material that forms the inner sleeve 14 is disposed within to form the inner sleeve 14 and fix the inner sleeve 14 with the outer labyrinth ring 16 of the seal ring 10. In some implementations, the mold from which the inner sleeve 14 is formed may define the inner surface 18 of the inner sleeve 14. It is contemplated that, in some implementations, the hollow 20 may be bored out of the polymeric material to form the inner surface 18 of the inner sleeve 14 that defines the hollow 20.

Referring now to FIGS. 1 and 4-6, in various implementations, the seal ring 10 includes a sealing element 58 that is disposed on the inner surface 18 of the inner sleeve 14 of the seal ring 10. As illustrated in FIG. 1, the O-ring 60 is configured to be received within the hollow 20 defined by the inner surface 18 of the inner sleeve 14 and abut the inner surface 18 to form a seal between the inner surface 18 and a shaft 22 extending through the hollow 20. In some implementations, the sealing element 58 may be a rubber bonded coating 72 that is applied to the inner surface 18 of the inner sleeve 14 of the seal ring 10. In some implementations, the rubber bonded coating 72 may be applied to the inner surface 18 of the inner sleeve 14 along a minority of the axial length of the inner sleeve 14. For example, as illustrated in FIGS. 4-6, the rubber bonded coating 72 is applied to the inner surface 18 of the inner sleeve 14 along about 15% of the axial length of the inner sleeve 14 at a position that is adjacent to an axial end of the inner sleeve 14. The rubber bonded coating 72 may extend between the inner surface 18 of the inner sleeve 14 and the shaft 22 that extends through the hollow 20 defined by the inner surface 18 of the inner sleeve 14 to prevent contaminants from entering therebetween.

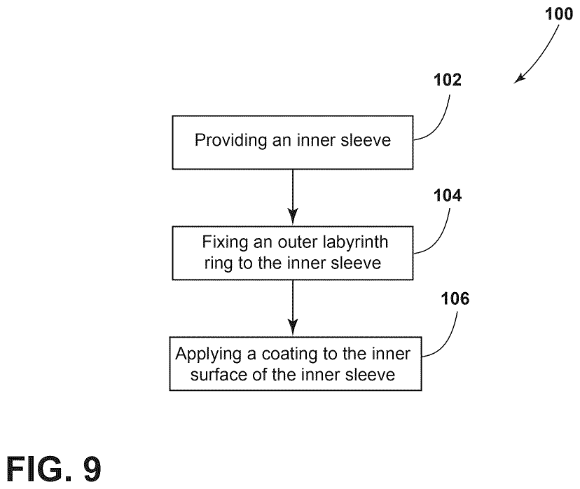

Referring now to FIG. 9, a method 100 of manufacturing a seal ring 10 for a bearing assembly 12 includes a step 102 of providing an inner sleeve 14 that includes an inner surface 18 and an outer surface 62 opposite the inner surface 18. In various implementations, the inner sleeve 14 provided at step 102 is a metal sleeve. In some implementations, the inner surface 18 and/or the outer surface 62 of the inner sleeve 14 is substantially cylindrical.

The method 100 of manufacturing the seal ring 10 for the bearing assembly 12 may include a step 104 of fixing an outer labyrinth ring 16 to the inner sleeve 14. In various implementations, the outer labyrinth ring 16 includes the interior surface 28 and the exterior surface 30 opposite the interior surface 28. In some embodiments, the outer labyrinth ring 16 is fixed to the inner sleeve 14 at step 104, such that the interior surface 28 of the outer labyrinth ring 16 and the outer surface 62 of the inner sleeve 14 cooperate to define the interior volume 66 disposed between the inner sleeve 14 and the outer labyrinth ring 16. In some embodiments, the step 104 of fixing the outer labyrinth ring 16 to the inner sleeve 14 comprises welding the outer labyrinth ring 16 to the inner sleeve 14. In an exemplary implementation, the step 104 of fixing the outer labyrinth ring 16 to the inner sleeve 14 comprises circumferentially welding the outer labyrinth ring 16 to the inner sleeve 14 at the first axial end 68 of the outer labyrinth ring 16 and circumferentially welding the outer labyrinth ring 16 to the inner sleeve 14 at the second axial end 70 of the outer labyrinth ring 16 that is opposite the first axial end 68. In various implementations, the outer labyrinth ring 16 is fixed to the inner sleeve 14 at step 104, such that the interior volume 66 is sealed from the exterior environment of the seal ring 10. In various implementations, the exterior surface 30 of the outer labyrinth ring 16 forms a plurality of crests 24 and at least one trough 26. For example, in the exemplary implementations illustrated in FIGS. 4-6, the exterior surface 30 of the outer labyrinth ring 16 forms first, second, and third crests 24A, 24B, and 24C, and first and second troughs 26A, 26B.

Referring still to FIG. 9, the method 100 of manufacturing the seal ring 10 for the bearing assembly 12 may include a step 106 of applying a rubber bonded coating 72 to the inner surface 18 of the inner sleeve 14 of the seal ring 10. In some implementations, the rubber bonded coating 72 may be applied to the inner surface 18 of the inner sleeve 14 at step 106 along a minority of the axial length of the inner sleeve 14. For example, in the embodiments illustrated in FIGS. 4-6, the rubber bonded coating 72 is applied to the inner surface 18 of the inner sleeve 14 along about 15% of the axial length of the inner sleeve 14 adjacent to an axial end of the inner sleeve 14.

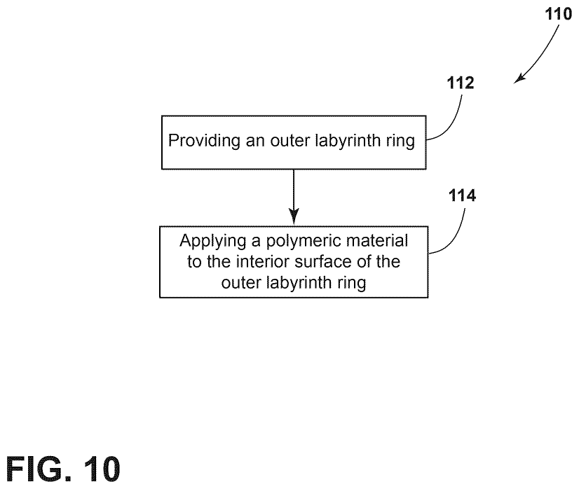

Referring now to FIG. 10, a method 110 of manufacturing a seal ring 10 for a bearing assembly 12 includes a step 112 of providing an outer labyrinth ring 16. In various implementations, the outer labyrinth ring 16 includes an interior surface 28 and an exterior surface 30 opposite the interior surface 28. The exterior surface 30 of the outer labyrinth ring 16 can form a plurality of crests 24 and at least one trough 26. For example, as illustrated in FIG. 8, the exterior surface 30 of the outer labyrinth ring 16 includes a first crest 24A, a second crest 24B, and a third crest 24C, wherein the second crest 24B is positioned axially between the first and third crests 24A, 24C, and the exterior surface 30 further includes the first trough 26A disposed axially between the first crest 24A and the second crest 24B and the second trough 26B disposed axially between the second crest 24B and the third crest 24C. In some implementations, the step 112 of providing the outer labyrinth ring 16 comprises hydroforming the outer labyrinth ring 16 to form the plurality of crests 24 and the at least one trough 26. It is contemplated that the outer labyrinth ring 16 may be formed in a variety of manners or provided in a pre-formed condition. In various implementations, the outer labyrinth ring 16 is formed of metal, such as steel.

Referring still to FIG. 10, the method 110 may include a step 114 of applying a polymeric material to the interior surface 28 of the outer labyrinth ring 16 for the forming of the inner sleeve 14 of the polymeric material that is configured to receive the shaft 22 therethrough. In some implementations, the polymeric material is a rubber and the interior surface 28 of the outer labyrinth ring 16 forms at least a portion of a mold for receiving the rubber therein. In some implementations, the polymeric material is a thermoplastic, and the interior surface 28 of the outer labyrinth ring 16 forms at least a portion of a mold for receiving the thermoplastic therein. Application of the polymeric material to the interior surface 28 of the outer labyrinth ring 16 and subsequent solidification of the polymeric material may result in adhesion of the polymeric material to the interior surface 28 of the outer labyrinth ring 16, in various embodiments.

The seal ring 10 and methods 100, 110 of manufacturing the seal ring 10 of the present disclosure may provide a variety of advantages. First, the seal ring 10 having the inner sleeve 14 and the outer labyrinth ring 16 fixed thereto may allow for a lightweight seal ring 10 that is cost effective. Second, utilizing the interior surface 28 of the outer labyrinth ring 16 as at least a portion of a mold into which polymeric material may be applied to form the seal ring 10 may result in efficient manufacturing of the seal ring 10 without need for additional steps of first forming the inner sleeve 14 and then adhering the inner sleeve 14 with the outer labyrinth ring 16. Third, the application of bonded rubber to the inner surface 18 of the inner sleeve 14 may enable appropriate sealing between the inner surface 18 of the inner sleeve 14 and a shaft 22 extending through a hollow 20 defined by the inner surface 18 with reduced parts relative to, for example, an O-ring sealing element 60 that is inserted into the hollow 20 of a seal ring 10.

It is to be understood that variations and modifications can be made on the aforementioned structure without departing from the concepts of the present disclosure, and further it is to be understood that such concepts are intended to be covered by the following claims unless these claims by their language expressly state otherwise.

### LIST OF REFERENCE NUMERALS

10 seal ring
10A first seal ring
10B second seal ring
12 bearing assembly
14 inner sleeve
16 outer labyrinth ring
18 inner surface
20 hollow
22 shaft
24 crest
24A first crest
24B second crest
24C third crest
26 trough
26A first trough
26B second trough
28 interior surface
30 exterior surface
32 housing
34 base
36 cap
38 annular interior portion
40 grooves
42 bearing
44 inner ring
46 outer ring
48 cage
50 rolling elements
52 retainer
52A first retainer
52B second retainer
54 radially outboard side
56 radially inboard side
58 sealing element
60 O-rings
62 outer surface
64 axis
66 interior volume
68 first axial end
70 second axial end
72 rubber bonded coating
100 method
102 step of providing an inner sleeve
104 step of fixing an outer labyrinth ring to the inner sleeve
106 step of applying a rubber bonded coating to the inner surface of the inner sleeve
110 method
112 step of providing an outer labyrinth ring
114 step of applying a polymeric material to the interior surface of the outer labyrinth ring

What is claimed is:

1. A seal ring for a bearing assembly, comprising:
an inner sleeve having an inner surface that defines a hollow for receiving a shaft therethrough; and
an outer labyrinth ring fixed to the inner sleeve and including an interior surface that faces the inner sleeve and an exterior surface opposite the interior surface, wherein the exterior surface forms a plurality of crests and at least one trough.

2. The seal ring of claim 1, wherein the outer labyrinth ring is formed of metal, and the inner sleeve is formed of a polymeric material that is applied to the interior surface of the outer labyrinth ring.

3. The seal ring of claim 1, wherein the inner sleeve includes an outer surface opposite the inner surface, and the inner sleeve and the outer labyrinth ring are fixed to each other such that the interior surface of the outer labyrinth ring and the outer surface of the inner sleeve cooperate to define an interior volume disposed between the inner sleeve and the outer labyrinth ring.

4. The seal ring of claim 3, wherein the interior volume is substantially devoid of solid and liquid material.

5. The seal ring of claim 3, wherein the inner sleeve is formed of metal, and the outer labyrinth ring is formed of metal.

6. The seal ring of claim 5, wherein the outer labyrinth ring is welded to the inner sleeve.

7. The seal ring of claim 6, wherein the outer labyrinth ring is welded to the inner sleeve circumferentially at a first axial end of the outer labyrinth ring and circumferentially at a second axial end of the outer labyrinth opposite the first axial end, such that the interior volume is sealed from an exterior environment of the seal ring.

8. The seal ring of claim 1, further comprising:
a rubber bonded coating applied to the inner surface of the inner sleeve along a minority of the axial length of the inner sleeve.

9. The seal ring of claim 1, wherein the exterior surface of the outer labyrinth ring forms the plurality of crests and the at least one trough, and the plurality of crests includes a first crest, a second crest, and a third crest, wherein the second crest is positioned axially between the first and third crests, and the at least one trough includes a first trough disposed axially between the first crest and the second crest and a second trough disposed axially between the second crest and the third crest.

10. A method of manufacturing a seal ring for a bearing assembly, comprising the steps of:
providing an inner sleeve that includes an inner surface and an outer surface opposite the inner surface; and
fixing an outer labyrinth ring that includes an interior surface and an exterior surface opposite the interior surface to the inner sleeve, such that the interior surface of the outer labyrinth ring and the outer surface of the inner sleeve cooperate to define an interior volume disposed between the inner sleeve and the outer labyrinth ring.

11. The method of claim 10, wherein the exterior surface of the outer labyrinth ring forms a plurality of crests and at least one trough.

12. The method of claim 10, wherein the step of fixing the outer labyrinth ring to the inner sleeve comprises welding the outer labyrinth ring to the inner sleeve.

13. The method of claim 12, wherein the step of fixing the outer labyrinth ring to the inner sleeve comprises circumferentially welding the outer labyrinth ring to the inner sleeve at a first axial end of the outer labyrinth ring and circumferentially welding the outer labyrinth ring to the inner sleeve at a second axial end of the outer labyrinth ring opposite the first axial end.

14. The method of claim 13, wherein the interior volume is sealed from an exterior environment of the seal ring.

15. The method of claim 10, further comprising the step of:
applying a rubber bonded coating to the inner surface of the inner sleeve along a minority of the axial length of the inner sleeve.

16. A method of manufacturing a seal ring for a bearing assembly, comprising the steps of:
providing an outer labyrinth ring that includes an interior surface and an exterior surface opposite the interior surface, wherein the exterior surface of the outer labyrinth ring forms a plurality of crests and at least one trough; and
applying a polymeric material to the interior surface of the outer labyrinth ring for the forming of an inner sleeve of the polymeric material that is configured to receive a shaft therethrough.

17. The method of claim 16, wherein the polymeric material is a rubber and the interior surface of the outer labyrinth ring forms at least a portion of a mold for receiving the rubber therein.

18. The method of claim 16, wherein the polymeric material is a thermoplastic and the interior surface of the outer labyrinth ring forms at least a portion of a mold for receiving the thermoplastic therein.

19. The method of claim 16, wherein the outer labyrinth ring is formed of metal.

20. The method of claim 16, wherein the exterior surface of the outer labyrinth ring forms the plurality of crests and the at least one trough, and the plurality of crests includes a first crest, a second crest, and a third crest, wherein the second crest is positioned axially between the first and third crests, and the at least one trough includes a first trough disposed axially between the first crest and the second crest and a second trough disposed axially between the second crest and the third crest.
